(19) United States
(12) Patent Application Publication
(10) Pub. No.: US 2026/0280388 A1
(43) Pub. Date: Sep. 17, 2026

(54) STATOR

(71) Applicant: TOYOTA JIDOSHA KABUSHIKI KAISHA, Toyota-shi (JP)

(72) Inventors: Yasunori SUZUKI, Kasugai-shi (JP); Jun Kawakami, Nishio-shi (JP); Yuki Yasube, Toyota-shi (JP)

(73) Assignee: TOYOTA JIDOSHA KABUSHIKI KAISHA, Toyota-shi (JP)

(21) Appl. No.: 19/460,978

(22) Filed: Jan. 27, 2026

(30) Foreign Application Priority Data
Mar. 11, 2025 (JP) 2025-038078

(51) Int. Cl. H02K 11/25; G01K 1/14

(52) U.S. Cl. CPC H02K 11/25; G01K 1/14

(57) ABSTRACT

A stator includes: a stator core including a yoke portion having an annular shape and a tooth portion that protrudes toward a radially inner side from an inner peripheral surface of the yoke portion; a cassette coil disposed on the tooth portion; a power lead electrically connected to the cassette coil; a molded member configured to cover a part of the power lead; and a thermistor integrally held by the molded member and exposed on a surface of the molded member, in which the thermistor is in contact with the cassette coil.

### CROSS-REFERENCE TO RELATED APPLICATION

This application claims priority to Japanese Patent Application No. 2025-038078 filed on Mar. 11, 2025. The disclosure of the above-identified application, including the specification, drawings, and claims, is incorporated by reference herein in its entirety.

### BACKGROUND

### 1. Technical Field

A technology disclosed in the present specification relates to a stator used in a rotating electric machine.

### 2. Description of Related Art

In order to measure a temperature of a coil provided in a stator, a technology of installing a thermistor in the coil has been developed. In order to improve reliability of measuring the temperature, a measure for continuously maintaining contact between the coil and the thermistor is needed. Japanese Unexamined Patent Application Publication No. 2007-221853 (JP 2007-221853 A) discloses a technology of fixing the thermistor to the coil by winding an insulating paper around the coil and the thermistor.

### SUMMARY

In the technology of JP 2007-221853 A, since the insulating paper is used, the number of components increases. The present specification provides a stator capable of measuring a temperature of a coil without increasing the number of components.

In an embodiment of a stator disclosed in the present specification, the stator may include:
a stator core including a yoke portion having an annular shape and a tooth portion that protrudes toward a radially inner side from an inner peripheral surface of the yoke portion; a cassette coil disposed on the tooth portion;
a power lead electrically connected to the cassette coil;
a molded member configured to cover a part of the power lead; and
a thermistor integrally held by the molded member and exposed on a surface of the molded member.
   The thermistor may be in contact with the cassette coil.

In the stator, the molded member configured to cover a part of the power lead also has a function of holding the thermistor. Further, the thermistor held by the molded member is exposed on the surface of the molded member and is in contact with the cassette coil. Therefore, in the stator, a temperature of the cassette coil can be measured without increasing the number of components.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic top view of a stator core of the present embodiment;

FIG. 2 is a schematic main part exploded perspective view of the stator core, the insulator, and the cassette coil of the stator of the present embodiment; and

FIG. 3 is a schematic main part plan view of the stator of the present embodiment.

### DETAILED DESCRIPTION OF EMBODIMENTS

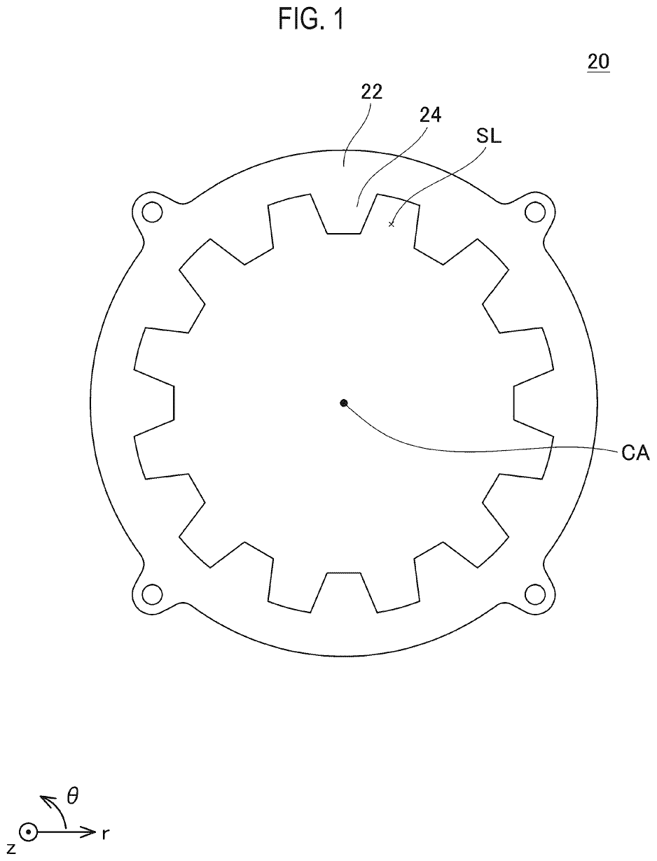

Hereinafter, the stator used in the rotating electric machine will be described with reference to the drawings. Here, with reference to FIG. 1, a cylindrical coordinate system configured with an axial direction, a radial direction, and a circumferential direction is defined with an annular stator core 20 provided in the stator as a reference. A z-axis shown in the drawing is an axis parallel to a central axis CA of the stator core 20 and indicates an axial direction of the stator core 20. In the present specification, a positive direction of the z-axis is referred to as one side in the axial direction, and a negative direction of the z-axis is referred to as the other side in the axial direction. An r-axis shown in the drawing is orthogonal to the z-axis and indicates a radial direction of the stator core 20. In the present specification, a direction away from the central axis CA along the r-axis is referred to as a radially outer side, and a direction approaching the central axis CA along the r-axis is referred to as a radially inner side. A θ-axis shown in the drawing is orthogonal to the z-axis and the r-axis and indicates a circumferential direction of the stator core 20.

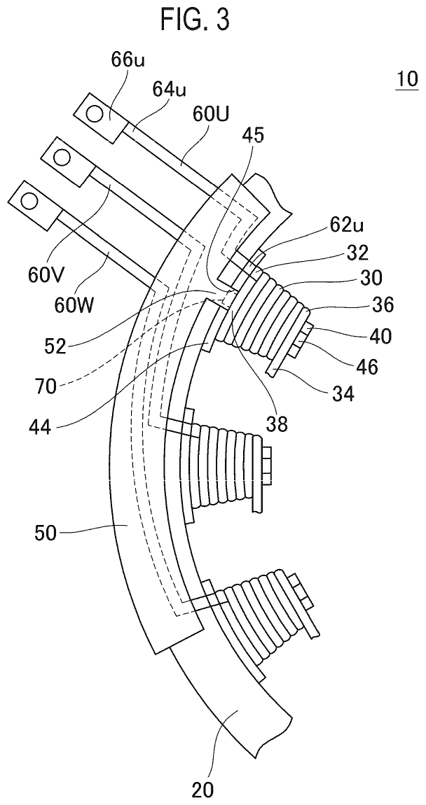

As shown in FIGS. 1 to 3, a stator 10 includes the stator core 20, a cassette coil 30, an insulator 40, a molded member 50, a plurality of power leads 60U, 60V, and 60W, and a thermistor 70.

The stator core 20 includes a yoke portion 22 and a plurality of teeth portions 24 that protrudes toward a radially inner side from an inner peripheral surface of the yoke portion 22. The number of the teeth portions 24 is not particularly limited and may be appropriately adjusted depending on the specification. The yoke portion 22 is an annular member centered on the central axis CA. Each of the teeth portions 24 extends from one end to the other end of the yoke portion 22 along the axial direction and is disposed to be spaced apart from each other in the circumferential direction. A slot SL is provided between the teeth portions 24 adjacent to each other in the circumferential direction. The stator core 20 may be configured by laminating a plurality of electromagnetic steel plates in the axial direction.

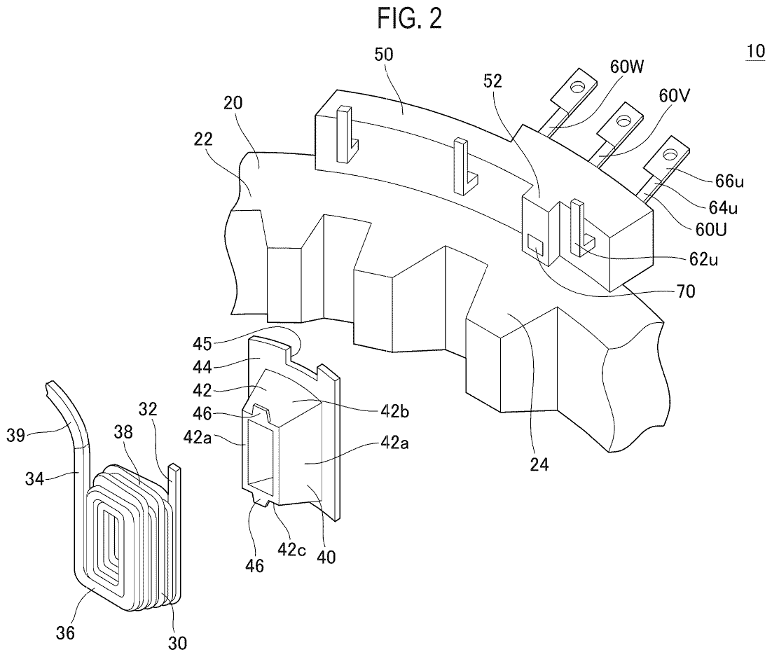

The cassette coil 30 includes a flat wire provided by coating a surface of a conductor with an insulator. The cassette coil 30 is a concentrated winding coil in which the flat wire is wound a predetermined number of times. One cassette coil 30 is disposed on each of the teeth portions 24. In FIG. 2, one cassette coil 30 is solely shown for the purpose of illustration.

The cassette coil 30 includes a first coil end 32 and a second coil end 34 that are located at both ends of the flat wire. The first coil end 32 and the second coil end 34 are connected to each other through a jumper 39, among a plurality of cassette coils 30 of the same phase, between the cassette coils 30 adjacent to each other in the circumferential direction of the stator core 20. However, the first coil end 32 of one cassette coil 30 among the cassette coils 30 of the same phase is connected to the power lead corresponding to the phase of the cassette coil 30.

The cassette coil 30 includes a front coil portion 36 and a rear coil portion 38 that are located at both ends of the stator core 20 in the radial direction. The front coil portion 36 is a coil portion of the cassette coil 30 that is located on the innermost side in the radial direction of the stator core 20. The front coil portion 36 may be a portion of a first turn connected to the second coil end 34. The rear coil portion 38 is a coil portion of the cassette coil 30 that is located on the outermost side in the radial direction of the stator core 20. The rear coil portion 38 may be a portion of a first turn connected to the first coil end 32.

The insulator 40 is a member attached to the tooth portion 24 of the stator core 20. The insulator 40 may be fixed to the tooth portion 24 by being fitted into the tooth portion 24, for example. The insulator 40 includes a tubular portion 42 that is interposed between the tooth portion 24 and the cassette coil 30 to insulate the two. In addition, the insulator 40 includes a flange portion 44 that is interposed between the yoke portion 22 and the cassette coil 30 to insulate the two, and a pair of claw portions 46 that fixes the cassette coil 30.

The tubular portion 42 of the insulator 40 is a tubular member that surrounds an outer peripheral surface of the tooth portion 24 excluding a top surface of the tooth portion 24. The tubular portion 42 includes a pair of side walls 42a, an upper wall 42b, and a lower wall 42c. The side walls 42a face the circumferential direction of the stator core 20. The upper wall 42b and the lower wall 42c face the axial direction of the stator core 20. Each of the side walls 42a extends between the upper wall 42b and the lower wall 42c.

The flange portion 44 of the insulator 40 is a plate-shaped member that protrudes from the outer peripheral surface of the tubular portion 42. The flange portion 44 protrudes from each of the side walls 42a, the upper wall 42b, or the lower wall 42c of the tubular portion 42 and surrounds the outer peripheral surface of the tubular portion 42. The flange portion 44 is disposed at an end of the tubular portion 42 on the radially outer side of the stator core 20, that is, an end close to the yoke portion 22. A notch portion 45 is provided in a part of the flange portion 44 that protrudes from the upper wall 42b of the tubular portion 42.

One claw portion 46 of the claw portions 46 of the insulator 40 protrudes from the outer peripheral surface of the upper wall 42b of the tubular portion 42. The other claw portion 46 of the claw portions 46 of the insulator 40 protrudes from the outer peripheral surface of the lower wall 42c of the tubular portion 42. Each of the claw portions 46 is disposed at an end of the tubular portion 42 on the radially inner side of the stator core 20. The front coil portion 36 of the cassette coil 30 is in contact with the claw portions 46 of the insulator 40, and the rear coil portion 38 of the cassette coil 30 is in contact with the flange portion 44 of the insulator 40. The claw portions 46 prevent the cassette coil 30 from coming off from the tubular portion 42.

The molded member 50 covers a part of each of the power leads 60U, 60V, and 60W. The molded member 50 covers each of the power leads 60U, 60V, and 60W at an interval and is a member that fixes each of the power leads 60U, 60V, and 60W at an interval. The molded member 50 is disposed on the yoke portion 22 of the stator core 20 and extends along the circumferential direction of the stator core 20 by a predetermined distance. The molded member 50 is made of a resin material and may be made of, for example, a polyphenylene sulfide resin (PPS) or a polyphthalamide resin (PPA). The molded member 50 is formed by insert molding the power leads 60U, 60V, and 60W and the thermistor 70 as insert products.

The molded member 50 has a protrusion 52 on a surface of the stator core 20 toward the radially inner side. The protrusion 52 is a portion that protrudes toward the radially inner side of the stator core 20 with respect to a peripheral surface. The protrusion 52 extends into the notch portion 45 of the insulator 40.

The power leads 60U, 60V, and 60W are wires that extend between the cassette coil 30 and a terminal board (not shown). The power leads 60U, 60V, and 60W include a U-phase power lead 60U, a V-phase power lead 60V, and a W-phase power lead 60W.

The U-phase power lead 60U extends through the molded member 50. A portion of the U-phase power lead 60U that extends along the circumferential direction of the stator core 20 on the yoke portion 22 is covered with the molded member 50. The U-phase power lead 60U includes a first power end 62u and a second power end 64u that are located at both ends of the U-phase power lead 60U. One end part including the first power end 62u is led out from a surface of the molded member 50 toward the radially inner side of the stator core 20 and is bent to be parallel to the axial direction of the stator core 20. The first power end 62u of the U-phase power lead 60U is connected to the first coil end 32 of one cassette coil 30 among the cassette coils 30 belonging to the U phase. The first power end 62u of the U-phase power lead 60U may be connected to the first coil end 32 of the cassette coil 30 by welding, for example. A U-phase terminal portion 66u is attached to the second power end 64u of the U-phase power lead 60U. The U-phase terminal portion 66u may be connected to a terminal board (not shown) through a fastening member, for example. The same applies to the V-phase power lead 60V and the W-phase power lead 60W, and the description thereof will be omitted.

The thermistor 70 is a temperature measurement element having a temperature measurement function. The thermistor 70 may be, for example, an element made of a semiconductor ceramic with electrical resistance value that changes depending on a temperature or an element made of a thermocouple with thermal electromotive force that changes depending on a temperature. The thermistor 70 is integrally held by the molded member 50.

The thermistor 70 is exposed on a surface of the molded member 50 toward the radially inner side of the stator core 20. The thermistor has a measuring unit at a portion exposed on the surface of the molded member 50. The thermistor 70 of this example is disposed in the protrusion 52 of the molded member 50. As a result, the thermistor 70 is in contact with the rear coil portion 38 of the cassette coil 30 through the notch portion 45 of the insulator 40.

The cassette coil 30 has a coil spring shape. Therefore, a biasing force is applied to the thermistor 70 in contact with the cassette coil 30 along the radial direction of the stator core 20. On the other hand, the molded member 50 that holds the thermistor 70 fixes the power leads 60U, 60V, and 60W, and generates a reaction force against the biasing force of the cassette coil 30 by elastic forces of the power leads 60U, 60V, and 60W. As a result, the contact state between the cassette coil 30 and the thermistor 70 is maintained. In particular, the molded member 50 covers a portion of each of the power leads 60U, 60V, and 60W that extends along the circumferential direction of the stator core 20. Therefore, the elastic forces of the power leads 60U, 60V, and 60W are strong in the radial direction of the stator core 20. Therefore, the contact state between the cassette coil 30 and the thermistor 70 is well maintained.

In addition, the molded member 50 also has a function of holding the thermistor 70 in addition to a function of fixing the power leads 60U, 60V, and 60W. Therefore, in the stator 10, a dedicated member for holding the thermistor 70 is not needed. The stator 10 can measure the temperature of the cassette coil 30 with a small number of components.

Further, in a step of manufacturing the stator 10, in a case where the molded member 50 is assembled to the stator core 20 on which the cassette coil 30 is attached, the contact state between the cassette coil 30 and the thermistor 70 is ensured. The power leads 60U, 60V, and 60W and the thermistor 70 are insert-molded in the molded member 50. As described above, the stator 10 has a structure in which the contact state between the cassette coil 30 and the thermistor 70 can be ensured by easy assembly work, so that manufacturing costs can be reduced.

Hereinafter, aspects disclosed in the present specification will be summarized. It should be noted that the technical elements described below are independent technical elements, and exhibit technical usefulness alone or in various combinations.

### Aspect 1

A stator including:
a stator core including a yoke portion having an annular shape and a tooth portion that protrudes toward a radially inner side from an inner peripheral surface of the yoke portion;
a cassette coil disposed on the tooth portion;
a power lead electrically connected to the cassette coil;
a molded member configured to cover a part of the power lead; and
a thermistor integrally held by the molded member and exposed on a surface of the molded member, in which the thermistor is in contact with the cassette coil.

### Aspect 2

The stator according to Aspect 1, in which the thermistor is exposed on the surface of the molded member toward the radially inner side of the stator core.

### Aspect 3

The stator according to Aspect 1, further including an insulator disposed between the tooth portion of the stator core and the cassette coil, in which:
the insulator includes a tubular portion and a flange portion that protrudes from an outer peripheral surface of the tubular portion;
a notch is provided in the flange portion;
the molded member includes a protrusion that extends into the notch of the flange portion; and
the thermistor is disposed in the protrusion of the molded member.

### Aspect 4

The stator according to any one of Aspects 1 to 3, in which:
the power lead includes a plurality of power leads; and
the molded member is configured to cover each of the power leads while the power leads are spaced apart from each other.

Although the embodiments have been described in detail above, these descriptions are merely examples and do not limit the scope of claims. The techniques described in the claims include various modifications and changes of the specific examples exemplified above. The technical elements described in the present specification or the drawings exhibit technical usefulness alone or in various combinations, and are not limited to the combinations described in the claims at the time of filing. Further, the techniques exemplified in the present specification or the drawings achieve a plurality of objectives at the same time, and achieving one of the objectives itself has technical usefulness.

What is claimed is:

1. A stator comprising:
a stator core including a yoke portion having an annular shape and a tooth portion that protrudes toward a radially inner side from an inner peripheral surface of the yoke portion;
a cassette coil disposed on the tooth portion;
a power lead electrically connected to the cassette coil;
a molded member configured to cover a part of the power lead; and
a thermistor integrally held by the molded member and exposed on a surface of the molded member, wherein the thermistor is in contact with the cassette coil.

2. The stator according to claim 1, wherein the thermistor is exposed on the surface of the molded member toward the radially inner side of the stator core.

3. The stator according to claim 1, further comprising an insulator disposed between the tooth portion of the stator core and the cassette coil, wherein:
the insulator includes a tubular portion and a flange portion that protrudes from an outer peripheral surface of the tubular portion;
a notch is provided in the flange portion;
the molded member includes a protrusion that extends into the notch of the flange portion; and
the thermistor is disposed in the protrusion of the molded member.

4. The stator according to claim 1, wherein:
the power lead includes a plurality of power leads; and
the molded member is configured to cover each of the power leads while the power leads are spaced apart from each other.
